(19) United States
(12) Patent Application Publication
(10) Pub. No.: US 2010/0119753 A1
(43) Pub. Date: May 13, 2010

(54) Polylefin Pipe Having Inherent Resistance To Thermooxidative Degradation

(75) Inventor: Heinz Vogt, Frankfurt (DE)

Correspondence Address: LyondellBasell Industries, 3801 WEST CHESTER PIKE, NEWTOWN SQUARE, PA, 19073, US

(73) Assignee: Basell Polyolefine GmbH, Wesseling (DE)

(21) Appl. No.: 12/452,700

(22) PCT Filed: Aug. 1, 2008
(86) PCT No.: PCT/EP2008/006347

§ 371 Date: Jan. 15, 2010

Related U.S. Application Data
(60) Provisional application No. 60/993,650, filed on Sep. 13, 2007.

(30) Foreign Application Priority Data
Aug. 7, 2007 (DE) 10 2007 037 134.0

(51) Int. Cl. B32B 1/08; B29C 47/78

(52) U.S. Cl. 428/36.9; 264/331.17

(57) ABSTRACT

The invention relates to a plastic pipe having improved resistance to thermooxidative degradation when this pipe is in long-term contact with liquids which comprise disinfectants having an oxidizing action. To achieve this, the pipe according to the invention has a fluorine coating on its inner surface.

The present invention relates to a pipe made of a polyolefinic molding composition, which has improved resistance to thermooxidative degradation, in particular when it is in long-term contact with liquids which comprise disinfectants having an oxidizing action.

Molding compositions comprising polyethylene (PE), polypropylene (PP) and poly-1-butene (PB-1) have for many years been used for producing plastic pipes for the distribution of cold and hot water in buildings.

Although the pipes made of the plastics mentioned have very good resistance to water, it has been found that their life is greatly reduced when the pipes come into contact with customary disinfectants which are normally added to the water for hygiene reasons. In general, small amounts of substances having an oxidizing action such as chlorine gas, sodium hypochlorite (chlorine bleaching liquor), calcium hypochlorite or chlorine dioxide are added as disinfectants to municipal water supplies. Hydrogen peroxide (H₂O₂) or ozone are sometimes also used.

The polyethylene pipes can be uncrosslinked or crosslinked. Crosslinking can be effected by the customary crosslinking processes employed in industry using organic peroxides, grafted-on vinyl silane esters or by means of high-energy radiation (gamma- or beta-waves).

It was therefore an object of the present invention to develop a novel protection of pipes based on PE, PP or PB-1 so that these have improved resistance to thermooxidative degradation when used for mains water in which disinfectants having an oxidizing action are present.

This object is achieved by a pipe of the general type mentioned at the outset whose distinguishing feature is that its inner surface has a halogen coating.

The coating of surfaces of containers made of polyethylene or other polyolefins with halogens, in particular chlorine or fluorine, is a proven technique for making the containers composed of these materials impermeable to vapors, e.g. of hydrocarbons. It is used to a large extent in the production of fuel containers for automobiles.

It has surprisingly been found that the coating of the inner surface of plastic pipes with halogen give the pipes treated in this way very good stability toward the oxidizing action of disinfectants in water over a long period of time. Halogens used for this application are bromine and preferably chlorine or fluorine, particularly preferably fluorine.

The coating of surfaces of plastics with halogen is normally achieved by exposing the surfaces to the action of a halogen-comprising, in particular chlorine- or fluorine- comprising, treatment gas for some time. This is particularly simple in the case of pipes because the treatment gas is simply passed through the pipe which has been produced beforehand in a customary manner by extrusion. The inner surface of the pipe is in this way coated by means of elemental chlorine or fluorine or else in the form of chlorocarbon or fluorocarbon or chlorinated hydrocarbon or fluorinated hydrocarbon compounds. A treatment gas is always a mixture of an inert gas and a reaction gas. Suitable reaction gases include not only elemental chlorine or fluorine but also chlorine fluoride, chlorine trifluoride, bromine trifluoride, chlorosulfonic acid, fluorosulfonic acid and similar gases. Suitable inert gases include not only nitrogen but also the noble gases, although the latter are significantly more expensive.

In fluorination, the inner surface of pipes is thus exposed to the action of elemental fluorine, which results in stepwise replacement by a free-radical mechanism of the C-H bonds by C-F bonds. To achieve an optimal and reliably reproducible surface effect, it is important to adhere to particular structural parameters. These are first and foremost the layer thickness, the uniformity of the fluorine coating, the distribution of CH₂, CHF and CF₂ groups and the depth profile.

The temperature at which halogen coating is carried out should be below the melting point of the plastic because otherwise undesirable surface effects which lead to roughening of the surface become noticeable. The temperature in the halogenation is preferably in the range from 50 to 130° C., particularly preferably from 70 to 120° C., very particularly preferably from 80 to 110° C.

Adherence to the temperatures indicated ensures that a virtually uniform temperature distribution is established in the interior of the pipe and a readily reproducible, uniform halogen coating is achieved.

As treatment gas, use is made of a mixture of from 90 to 99.5% by volume of inert gas and from 0.5 to 10% by volume of reaction gas, with the mixing ratio preferably being from 95 to 99% by volume of inert gas and from 1 to 5% by volume of reaction gas.

The treatment gas acts on the inner surface of the plastic pipe for a time of from 10 to 100 s at the treatment temperature, preferably from 20 to 80 s. This normally gives a fluorine coating in the range from 10 to 60 g/cm², preferably from 20 to 50 g/cm².

Thermoplastic polyolefins which are particularly suitable for the purposes of the invention are PE, PP or PB-1 or copolymers of these with further olefinic monomers having from 3 to 10 carbon atoms which can be readily processed by extrusion to produce pipes.

PE molding compositions which are suitable for the purposes of the invention have, for example, a density at a temperature of 23° C. in the range from 0.93 to 0.965 g/cm³ and a melt index MFR_{190/5} in the range from 0.1 to 2 g/10 min.

PP molding compositions which are suitable for the purposes of the invention can be, for example, high molecular weight homopolymers, random copolymers or block copolymers having a melt index MFR_{230/5} in the range from 0.1 to 2 g/10 min.

PB-1 molding compositions which are suitable for the purposes of the invention can be, for example, homopolymers or copolymers having a melt index MFR_{190/2.16} in the range from 0.1 to 1 g/10 min and a density at a temperature of 23° C. in the range from 0.92 to 0.95 g/cm³.

A molding composition which is suitable for the purposes of the invention can comprise further additives in addition to the thermoplastic polyolefin. Such additives are preferably heat and processing stabilizers, antioxidants, UV absorbers, light stabilizers, metal deactivators, peroxide-destroying compounds, organic peroxides, basic costabilizers in amounts of from 0 to 10% by weight, preferably from 0 to 5% by weight, and also carbon black, fillers, pigments or combinations of these in total amounts of from 0 to 30% by weight, based on the total weight of the mixture.

As heat stabilizers, the molding composition can comprise phenolic antioxidants, in particular pentaerythrityl 3,5-di-tert-butyl-4-hydroxyphenylpropionate which is obtainable under the trade name IRGANOX from Ciba Specialties, Germany.

### EXAMPLE 1

A high molecular weight, medium density PE powder having a density of 0.946 g/cm³ and a melt flow index MI_{190/5} of 0.3 g/10 min was admixed with 0.35% of IRGANOX 1330 and pelletized at a melt temperature of 220° C. on a ZSK 53 from Coperion Werner & Pfleiderer GmbH & Co KG. The pellets were processed at melt temperatures of 220° C. on a pipe extrusion unit from Battenfeld to produce pipes which had a diameter of 16×2 mm and were subsequently crosslinked by means of electron beams. The radiation dose applied was 120 kGy. The degree of crosslinking was determined in accordance with DIN EN 16892 and was 66%.

The pipe produced in this way was then brought to a temperature of 90° C. and a treatment gas composed of nitrogen plus 1.1% by volume of elemental fluorine was passed through it for a time of 40 s.

A long-term pressure test on the pipe which had been treated in this way was carried out in accordance with ASTM F2023 at 115° C. in the presence of 4 ppm of chlorine at a pressure of 1.58 MPa. The time to failure achieved is shown in table 1.

### COMPARATIVE EXAMPLE

For comparison, a commercial PEXc material Lupolen 4261A Q416 from Basell was extruded to produce pipes having dimensions of 16×2 mm and radiation-crosslinked with 120 kGy. The degree of crosslinking was found to be 63%.

A long-term pressure test was carried out on the crosslinked pipes at 115° C. in the presence of 4 ppm of chlorine at a pressure of 1.58 MPa. Testing was carried out in accordance with ASTM F2023.

TABLE 1

| | Time of pressure test |
|---|---|
| Example No. | to rupture in h |
| Example 1 | 2356 |
| Comparison | 524 |

1. A pipe made of a polyolefinic molding composition, which has improved resistance to thermooxidative degradation wherein the inner surface of the pipe has a halogen coating.

2. The pipe according to claim 1, wherein bromine or fluorine is used as the halogen.

3. The pipe according to claim 1 whose inner surface is coated by means of elemental bromine, chlorine or fluorine or in the form of a chlorocarbon, fluorocarbon, chlorinated hydrocarbon or fluorinated hydrocarbon compound.

4. The pipe according to claim 1 which comprises polyethylene, polypropylene or poly-1-butene or copolymers of these with further olefinic monomers having from 3 to 10 carbon atoms which can be processed by extrusion to produce pipes.

5. The pipe according to claim 1 which comprises polyethylene having a density at a temperature of 23° C. in the range from 0.93 to 0.965 g/cm³ and a melt index MFR_{190/5} in the range from 0.1 to 2 g/10 min.

6. The pipe according to claim 1 which comprises a high molecular weight homopolymer, random copolymer or block copolymer of propylene having a melt index MFR_{230/5} in the range from 0.1 to 2 g/10 min.

7. The pipe according to claim 1 which comprises a poly-1-butene as homopolymer or copolymer having a melt index MFR_{190/2.16} in the range from 0.1 to 1 g/10 min and a density at a temperature of 23° C. in the range from 0.92 to 0.95 g/cm³.

8. A process for producing a pipe according to claim 1, which comprises melting the polyolefinic molding composition in an extruder, extruding the molten molding composition through an annular die and subsequently cooling it, wherein the inner surface of the pipe is exposed to the action of a halogen-comprising, treatment gas before or after cooling.

9. The process according to claim 8, wherein a mixture of an inert gas and a reaction gas is used as the treatment gas.

10. The process according to claim 9, wherein elemental chlorine or fluorine or chlorine fluoride, chlorine trifluoride, bromine trifluoride, chlorosulfonic acid, or fluorosulfonic acid is used as the reaction gas.

11. The process according to claim 9, wherein nitrogen or a noble gas is used as the inert gas.

12. The process according to claim 8, wherein the temperature at which the treatment gas is allowed to act on the inner surface of the pipe is below the melting point of the plastic.

13. The process according to claim 9, wherein a mixture of from 90 to 99.5% by volume of inert gas and from 0.5 to 10% by volume of reaction gas is used as the treatment gas.

14. The process according to claim 8, wherein the treatment gas is allowed to act on the inner surface of the plastic pipe for a time of from 10 to 100 s at the treatment temperature.
